(19) United States
(12) Patent Application Publication
(10) Pub. No.: US 2016/0199764 A1
(43) Pub. Date: Jul. 14, 2016

(54) Device for measuring the overfill of filter elements comprising filter cakes in pressure filters

(71) Applicant: DRM, DR. MÜLLER AG, Männedorf (CH)

(72) Inventor: PATRICK MUELLER, MAENNEDORF (CH)

(21) Appl. No.: 14/914,353

(22) PCT Filed: Jun. 23, 2014
(86) PCT No.: PCT/CH2014/000087

§ 371 Date: Feb. 25, 2016

(30) Foreign Application Priority Data
Dec. 4, 2013 (CH) 2004/13

(51) Int. Cl. B01D 35/143

(52) U.S. Cl. CPC B01D 35/1435

(57) ABSTRACT

A filter device for preventing the overfill of filter elements with filter cake includes a filter housing and filtrate collection tubes. Sensors for measuring force are provided within the filter housing. The sensors are arranged over the filter elements at the closed end of the filtrate collection tubes. Detected changes in force by the sensors provide an indication of an increasing cake buildup.

The present invention relates to a method and a device for measuring the overfill of filter elements comprising filter cakes in pressure filters.

Pressure-filter systems having horizontally or vertically arranged filter elements in a pressure vessel can be acted upon by a filter capacity of solids that exceeds a permissible level if there are high concentrations of solids or if filtration cycles are too long. This solid material settles in the hollow spaces between the filter elements and fills them completely. Once these have become filled, process complications arise, such as, for example, increased difficulty in removing the filter cake or deformations of the filter elements, up to irreparable damage to the internal parts. The resultant repair costs can be considerable.

In order to handle this problem, various instruments were used in the past to measure the thickness of the cake. These were usually highly unreliable, due to the usually irregular build-up of the cake and the difficult nature of adjusting such measuring instruments in a closed pressure vessel.

DE 26 19 864 A1 discloses a device for monitoring the layer thickness of the filter cake forming on a filter element within a filter container, in particular in a centrifugal cleaning filter. In this case, when a measuring plate is contacted by the filter cake, the resulting pressure difference causes the measuring plate to be pushed downward.

DE 20 34 308 A1 discloses a method in which a separate measuring filter apparatus, as the reference filter, is inserted parallel to the main filter and makes it possible to observe the cake build-up through a viewing window during operation and to thereby determine the thickness of the cake. It is assumed here that the cake builds up in the reference filter as quickly as it does in the main filter.

U.S. Pat. No. 4,070,288 A describes a method for detecting the cake thickness by means of a special measuring plate which is displaced when the cake accumulates on the plate.

This system has proven to be problematic in practical application because, when the cake is removed by rotating the filter elements, the measuring plate is displaced, which adversely affects the measurement. Since, in practical application, the filter cakes build up in an irregular manner and the installed measuring plate measures the cake thickness only at a single point, this measurement procedure has proven to be not sufficiently representative. As a result, this procedure has not proven to be effective and was rarely implemented in practical application.

The problem addressed by the invention is that of using a device to protect pressure filters and their filter elements from overfill with an excessive amount of solids.

A further problem addressed by the invention is that of measuring miniscule deformations of the filter elements in order to trigger a corresponding alarm. An additional mechanical measuring system shall be eliminated.

These problems are solved according to the invention by arranging sensors over the filter elements at the closed end of the filtrate collection tubes.

According to the invention, neither the filter cake nor a measuring plate is used to trigger a signal. Instead, the forces acting directly on the filter elements are determined and these are used to trigger a signal. This has the decisive advantage that the measurement is not dependent on the position of the measuring instruments, but rather that the overall loading of the filter elements with filter cake is detected. In practical application it has been shown that the presence of the measuring probe at one point influences the build-up of filter cake, thereby corrupting the measured result. It is therefore of primary significance that it is not the cake thickness but rather the overall load that is measured.

In contrast to the identified prior art, the system proposed here is based on a different approach, in which the cake thickness is not measured, but rather the displacement or deformation of the elements is detected. Measuring probes are mounted on individual elements or groups of elements, which measuring probes measure the forces acting on the element or the local displacement of the element or of the element group.

Provided the measuring system is precise enough to also detect small deviations and to be capable of detecting the overfill process at the very beginning, the forces generated by the solid are still too small to cause mechanical damage to the elements. It can be assumed that the elasticity of the material used to construct the filter elements is great enough and, therefore, permanent damage can be avoided.

In addition, mechanical deformation can be further delayed by connecting the elements or element groups to the filter apparatus via a spring mounting. The elasticity can be further increased in this way.

Since the solid build-up in the filter often behaves differently at different points, it is usually insufficient to measure the strain on only one filter element or group. It therefore makes sense to use a row of measuring probes in the filter system.

Moreover, such a measuring system is suitable for use in an apparatus provided with vertical filter elements and horizontal registers in which measuring probes are mounted at the register ends (element groups) in order to detect the displacement thereof. It is also conceivable, however, to mount such measuring probes at other points of the element groups.

The invention is explained in greater detail with reference to a drawing.

Therein:

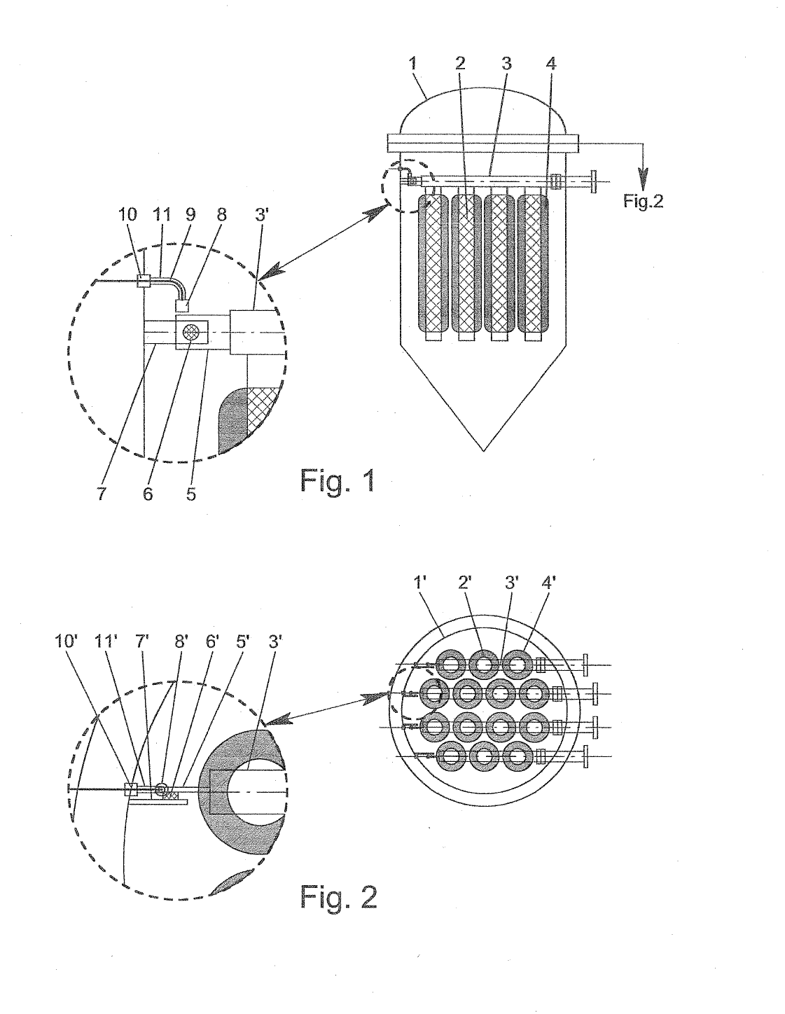

FIG. 1 shows a cross-section of the device according to the invention with an enlarged detailed view.

FIG. 2 shows a cross-section of the device according to the invention from above with an enlarged detailed view.

In FIG. 1 a housing of a cartridge filter consisting of filter elements 2 is labeled with reference number 1. FIG. 1 also shows a register of filter elements 2, and a filtrate collection tube 3 having an open end for the filtrate discharge and a closed end, which is fastened on the filter housing 1 via a coupling 5 having a holder 7 of the register. The coupling 5 can additionally include a spring system 6 in order to increase the elasticity.

The sensors 8 are fastened on a measuring probe guide 11, which is connected to the feedthrough 10.

The cables 9 of the sensors 8, 8′ are routed out of the pressure vessel 1 via one or more pressure-resistant feedthroughs 10.

In FIG. 2, identical parts are described using the same reference numbers, with apostrophes.

A cross-section of the filter housing 1′ comprising filter elements 2′ from above, with an enlarged detailed view of the rear fastening of the filtrate collection tube 3′.

The measuring probes are placed in such a way that they can detect the distance to the registers. Small deviations of a few millimeters are detected and an alarm is therefore triggered. Proximity sensors, for example, which build up a local magnetic field and can therefore detect metals, are used to perform the measurement. It is also possible to use solenoid switches (reed switches), however. In that case, a small magnet, which activates the switch, is additionally mounted on the filter element.

As an alternative, a force-measuring probe, which measures the variations in force, can be mounted between the register end piece and the register suspension. Such changes in force provide an indication of the cake thickness caused by the build-up of the solids. Increased forces can trigger an alarm in this case as well.

1. A filter device that prevents an overfill of filter elements with filter cake, the filter device comprising:
a filter housing;
filter elements provided within the filter housing;
filtrate collection tubes provided within the filter housing, the filtrate tubes having an open end and a closed end; and
sensors for measuring force provided within the filter housing;
wherein the sensors are arranged over the filter elements at the closed end of filtrate collection tubes.

2. The filter device according to claim 2, wherein a spring is provided between the closed ends of the filtrate collection tubes and holders arranged on the filter housing.

3. The filter device according to claim 3, wherein an elastomer is provided between the closed ends of the filtrate collection tubes and the holders arranged on the filter housing.

4. The filter device according to claim 1, wherein the sensors generate signals representative of the measured forces.
